(19) United States
(12) Patent Application Publication
(10) Pub. No.: US 2007/0217520 A1
(43) Pub. Date: Sep. 20, 2007

(54) Apparatuses and methods for post-processing video images

(75) Inventors: Byoung-Chan Kim, Suwon-si (KR); Soon-Jae Cho, Suwon-si (KR)

Correspondence Address: HARNESS, DICKEY & PIERCE, P.L.C., P.O. BOX 8910, RESTON, VA, 20195, US

(73) Assignee: SAMSUNG ELECTRONICS CO., LTD.

(21) Appl. No.: 11/717,692

(22) Filed: Mar. 14, 2007

(30) Foreign Application Priority Data
Mar. 15, 2006 (KR) 10-2006-0023889

(51) Int. Cl. H04B 1/66

(52) U.S. Cl. 375/240.27; 375/240.29

(57) ABSTRACT

An apparatus for post-processing a video image may include a filter configured to remove artifacts from pictures decoded by a video decoder; a differential picture encoder configured to produce compressed differential pictures based on the decoded pictures and the pictures filtered by the filter; and a differential picture decoder configured to reconstruct the filtered pictures based on the decoded pictures and the compressed differential pictures. A method for post-processing a video image may include filtering pictures decoded by a video decoder to remove artifacts from the decoded pictures; producing compressed differential pictures based on the decoded pictures and the filtered pictures; and reconstructing the filtered pictures based on the decoded pictures and the compressed differential pictures. A video image system may include a video decoder; a filter; a differential picture encoder; a memory; a differential picture decoder; and a display unit.

### PRIORITY STATEMENT

This application claims priority from Korean Patent Application No. 10-2006-0023889, filed on Mar. 15, 2006, in the Korean Intellectual Property Office (KIPO), the entire contents of which are incorporated herein by reference.

### BACKGROUND

1. Field

Example embodiments relate to processing video images. Also, example embodiments relate to apparatuses and methods for post-processing video images.

2. Description of Related Art

Generally, video compressing techniques developed by the Moving Picture Experts Group (MPEG) of the International Organization for Standardization (ISO)/International Electrotechnical Commission (IEC) are adopted for a variety of applications. For example, a video signal in a digital television broadcasting system is compressed and transmitted according to the MPEG-2 standard, and the video signal in a Digital Multimedia Broadcasting (DMB) system is compressed and transmitted according to the H.264 standard.

A video encoder widely used in a current video signal processing system removes inter-picture redundancy using a temporal model based on motion estimation and motion compensation and removes intra-picture redundancy using spatial transformation and quantization based on a Discrete Cosine Transform (DCT). Furthermore the video encoder removes statistical redundancy using entropy coding. The DCT is performed on a block-by-block basis in which each block has an 8×8 or a 4×4 size. The energy in an image block may be concentrated in a low frequency domain through the DCT. The block processed by the DCT is quantized and a part of an original video image may be lost during the quantization process.

A video decoder performs a video image decompressing operation in the inverse order of a compressing operation of the video encoder. Accordingly, the video decoder performs an entropy decoding, an inverse quantization and an Inverse Discrete Cosine Transform (IDCT) of the coded video image, and then reconstructs the video image on the basis of the motion compensation. Blocking artifacts may occur in the video image reconstructed by the video decoder because the DCT is performed on a block-by-block basis. Also, ringing artifacts may occur near edges of the reconstructed video image.

The H.264 video encoder may include an in-loop filter for reducing the artifacts that may occur in the reconstructed video image to increase an efficiency of the video encoding. However, in-loop filtering requires a great amount of computation, and thus the H.264 video encoder does not always perform the in-loop filtering. The MPEG-2 video encoder performs the video coding without the in-loop filter. Accordingly, the blocking-artifact problem and the ringing-artifact problem may still exist in the video encoders.

To solve such a problem, a video decoder may include a post filter. The post filter reduces the blocking and ringing artifacts in pictures reconstructed by the video decoder.

According to the MPEG-2 standard, the pictures may be classified into the following three different coded pictures: an intra-picture (referred to in the discussion that follows as an “I picture”), a prediction picture (referred to in the discussion that follows as a “P picture”), and a bi-directional prediction picture (referred to in the discussion that follows as a “B picture”). The I-picture is coded without referring to the other pictures, and the P picture is coded through motion detection and compensation using the I-picture or another P picture as a reference picture. The B picture is coded using two reference pictures. The intra-picture indicates the picture, such as the I picture, that is coded without referring to any other picture, and an inter-picture indicates the picture, such as the P picture and the B picture, that are coded with referring to at least one other picture.

In video compression and decompression techniques, a prediction picture (or frame) is required for coding another picture or decoding the coded picture. The picture that is used for generating such a prediction frame is referred to as a reference picture. In the MPEG-2 type video compression and decompression techniques, the I and P pictures can be used as the reference picture, but the B picture cannot be used as the reference picture.

FIG. 1 is a block diagram illustrating a conventional video image system.

Referring to FIG. 1, the video image system 100 includes a video decoder 110 for reconstructing pictures, a deblocking filter 120 for filtering the reconstructed pictures, a display unit 130 for displaying the filtered pictures, a memory 150 for buffering the pictures, and a bus 140.

The video decoder 110 decodes a compressed video data to reconstruct I, P and B pictures. In order to generating a prediction frame necessary during a decoding process for reconstructing the I, P, and B pictures, the video decoder 110 receives the I and P pictures as the reference pictures from the memory 150. The video decoder 110 uses the prediction frame to decode the compressed video data. The video decoder 110 provides the I, P, and B pictures reconstructed in the decoding process to the deblocking filter 120, and the I and P pictures are stored in the memory 150 for the next decoding process.

The deblocking filter 120 filters the I, P, and B pictures, and the filtered pictures, which are referred to as an I′ picture, a P′ picture, and a B′ picture, respectively, are stored in the memory 150.

The display unit 130 receives the filtered I′, P′, and B′ pictures to display the filtered I′, P′, and B′ pictures.

The filtered picture is almost the same as an original picture that became the filtered picture. The video image system 100 stores both the original picture and the filtered picture in the memory 150 and, thus, requires a lot of memory capacity. Also, the video image system 100 has a problem that a utilization of the bus 140 is inefficient because the pictures filtered in the deblocking filter 120 are transmitted as is to the memory 150.

### SUMMARY

Example embodiments may provide an apparatus for post-processing a video image. The apparatus may include a filter configured to remove artifacts from pictures decoded by a video decoder; a differential picture encoder configured to produce compressed differential pictures based on the decoded pictures and the pictures filtered by the filter; and/or a differential picture decoder configured to reconstruct the filtered pictures based on the decoded pictures and the compressed differential pictures.

Example embodiments may provide an apparatus for post-processing a video image. The apparatus may include a filter configured to remove artifacts from pictures decoded by a video decoder; a differential region encoder configured to produce a compressed differential region or regions based on a filtered reference region or regions and a decoded reference region or regions corresponding to the filtered reference region or regions; and/or a differential region decoder configured to reconstruct the filtered reference region or regions based on the corresponding decoded reference region or regions and the compressed differential region or regions. The filtered reference region or regions may be included in the pictures filtered by the filter. The decoded reference region or regions may be included in the decoded pictures.

Example embodiments may provide a method for post-processing a video image. The method may include filtering pictures decoded by a video decoder to remove artifacts from the decoded pictures; producing compressed differential pictures based on the decoded pictures and the filtered pictures; and/or reconstructing the filtered pictures based on the decoded pictures and the compressed differential pictures.

Example embodiments may provide a video image system. The system may include a video decoder configured to decode coded video images in order to reconstruct reference pictures and non-reference pictures; a filter configured to remove artifacts from the reference pictures and the non-reference pictures; a differential picture encoder configured to produce compressed differential pictures based on the reference pictures and the filtered reference pictures; a memory configured to store the reference pictures, the filtered non-reference pictures, and the compressed differential pictures; a differential picture decoder configured to reconstruct the filtered reference pictures based on the reference pictures and the compressed differential pictures; and/or a display unit configured to display the filtered non-reference pictures and the reconstructed filtered reference pictures. The reference pictures may be used in a decoding process. The non-reference pictures may not be used in the decoding process.

Accordingly, memory-space requirements and bus occupancy may be reduced.

### BRIEF DESCRIPTION OF THE DRAWINGS

The above and/or other aspects and advantages will become more apparent and more readily appreciated from the following detailed description of example embodiments taken in conjunction with the accompanying drawings, in which:

FIG. 1 is a block diagram illustrating a conventional video image system;

FIG. 2 is a block diagram illustrating a video image system that includes a video post-processing apparatus according to an example embodiment;

FIG. 3 is a block diagram illustrating an example embodiment of a differential picture encoder in the video image system of FIG. 2;

FIG. 4 is a block diagram illustrating another example embodiment of a differential picture encoder in the video image system of FIG. 2;

FIG. 5 is a block diagram illustrating an example embodiment of a differential picture decoder in the video image system of FIG. 2; and

FIG. 6 is a block diagram illustrating a video image system that includes a video image post-processing apparatus according to another example embodiment.

### DETAILED DESCRIPTION OF EXAMPLE EMBODIMENTS

Example embodiments now will be described more fully with reference to the accompanying drawings. Embodiments, however, may be embodied in many different forms and should not be construed as being limited to the example embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when a component is referred to as being “on,” “connected to,” or “coupled to” another component, it may be directly on, connected to, or coupled to the other component or intervening components may be present. In contrast, when a component is referred to as being “directly on,” “directly connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. Thus, a first element, component, region, layer, and/or section discussed below could be termed a second element, component, region, layer, and/or section without departing from the teachings of the example embodiments.

Spatially relative terms, such as “beneath,” “below,” “lower,” “above,” “upper,” and the like may be used herein for ease of description to describe one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, and/or components.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, that may be illustrated in the accompanying drawings, wherein like reference numerals may refer to the like components throughout.

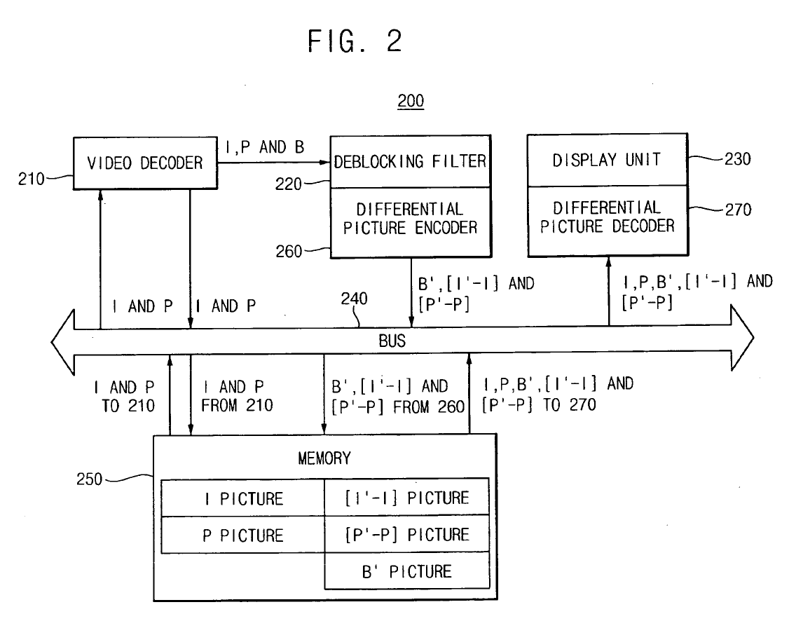

FIG. 2 is a block diagram illustrating a video image system that includes a video post-processing apparatus according to an example embodiment.

Referring to FIG. 2, the video image system 200 may include a video decoder 210, a deblocking filter 220, a display unit 230, a bus 240, and/or a memory 250. The video image system 200 further may include a differential picture encoder 260 and/or a differential picture decoder 270 to reduce memory-space requirements and/or the amount of data transferred through the bus.

The video decoder 210 may decode compressed video data to reconstruct I, P, and/or B pictures. The video decoder 210 may receive the I and/or P pictures reconstructed in the preceding decoding process as reference pictures from the memory 250 so as to produce a prediction frame required in the decoding process for reconstructing the I, P, and/or B pictures. The video decoder 210 may decode the compressed video data using the prediction frame. The video decoder 210 may provide the I, P, and/or B pictures reconstructed in the preceding decoding process to the deblocking filter 220, and/or may store the I and P pictures in the memory 250 for performing the next decoding process.

The deblocking filter 220 may filter the reconstructed 1, P, and/or B pictures. The differential picture encoder 260 may encode the filtered reference pictures (I′ and/or P′ pictures of the filtered pictures I′, P′, and/or B′) to produce the compressed differential pictures I′-I and P′-P.

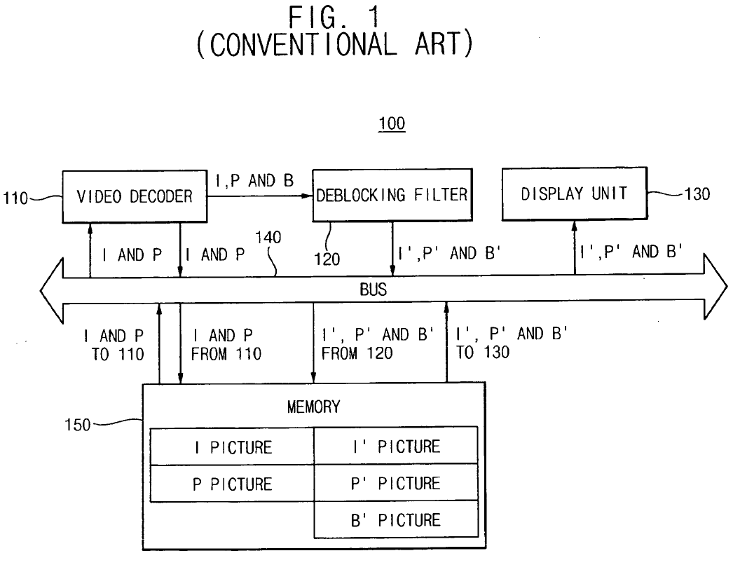

The compressed differential pictures I′-I and/or P′-P and/or the filtered non-reference picture B′ may be stored in the memory 250. The compressed differential pictures I′-I and/or P′-P may be much smaller in size than the filtered pictures I′ and/or P′. Accordingly, the memory 250 may be implemented with a size smaller than the memory 150 in the video image system 100 shown in FIG. 1.

The compressed differential pictures I′-I and/or P′-P, the filtered non-reference picture B′, and/or the reference pictures I and/or P may be provided to the differential picture decoder 270. The differential picture decoder 270 may reconstruct the filtered reference pictures I′ and/or P′ using the compressed differential pictures I′-I and/or P′-P and/or the reference pictures I and/or P, and may provide the filtered reference pictures I′ and/or P′ to the display unit 230.

The display unit 230 may display the filtered reference pictures I′ and/or P′ and/or the filtered non-reference picture B′.

The deblocking filter 220, the differential picture encoder 260, and/or the differential picture decoder 270 may perform a function of the video post-processing apparatus by removing artifacts from the pictures reconstructed by the video decoder 210.

In performing the function of the video post-processing apparatus, the amounts of data transferred through the buses 140 and 240 in the video image systems 100 and 200 in FIGS. 1 and 2 respectively will be discussed below.

In FIG. 1, the filtered pictures I′, P′, and/or B′ in the deblocking filter 120 may be transferred through the bus 140 to the memory 150 and/or may be transferred from the memory 150 through the bus 140 to the display unit 130. In other words, in the case in which the video image system 100 in FIG. 1 post-processes the I, P, and/or B pictures, the filtered pictures I′, P′, and/or B′ may occupy the transfer capacity of the bus 140 while the filtered pictures I′, P′, and/or B′ are recorded in the memory 150 and/or while the pictures I′, P′, and/or B′ are transferred to the display unit 130.

In FIG. 2, in the case in which the video image system 200 post-processes the pictures I, P and B, the compressed differential pictures I′-I and P′-P and the filtered non-reference picture B′ may be transferred through the bus 240 to the memory 250 and/or may be transferred from the memory 250 through the bus 240 to the differential picture decoder 270. That is, in the case in which the video image system 200 post-processes the pictures I, P, and/or B, the compressed differential pictures I′-I and/or P′-P and/or the filtered non-reference picture B′ may occupy the bandwidth of the bus 240 while the compressed differential pictures I′-I and/or P′-P and/or the filtered non-reference picture B′ are recorded in the memory 250 and/or while the compressed differential pictures I′-I and/or P′-P and/or the filtered non-reference picture B′ are transferred to the differential picture decoder 270.

The I picture and the P picture may have data quantities equal to the I′ picture and the P′ picture, respectively. Equation 1 represents the condition that the video image system 200 shown in FIG. 2 may occupy a bus capacity smaller than the video image system 100 shown in FIG. 1.

2*Diff_{—}PIC<PIC [Equation 1]

where the Diff_PIC designates data quantity for the compressed differential pictures and the PIC designates data quantity for the filtered reference pictures. Generally, the condition for the Equation 1 may be satisfied because the data quantity for a compressed differential picture may be much less than that for a filtered reference picture.

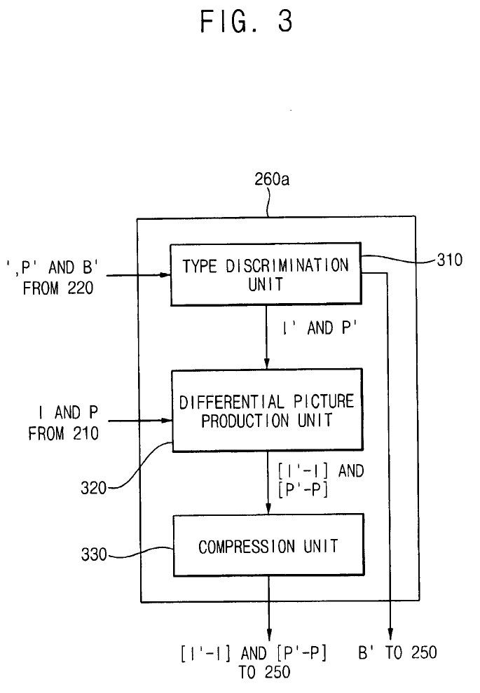

FIG. 3 is a block diagram illustrating an example embodiment of a differential picture encoder in the video image system of FIG. 2.

Referring to FIG. 3, the differential picture encoder 260a may include a type discrimination unit 310, a differential picture production unit 320, and/or a compression unit 330.

The differential picture encoder 260a may receive pictures I and/or P, reconstructed using video decoding, and filtered pictures I′, P′, and/or B′, and may output compressed differential pictures I′-I and/or P′-P and/or filtered non-reference picture B′.

The type discrimination unit 310 may receive the filtered pictures I′, P′, and/or B′ and/or may discriminate according to the type of received picture. When the type of received picture is an I picture or a P picture, the differential picture production unit 320 may compare the filtered picture with the corresponding reconstructed picture to produce a differential picture. The compression unit 330 may compress the differential picture using, for example, a lossless compression method. In an example embodiment, the compression unit 330 may code the differential picture using, for example, a run length coding (RLC) method and may again code the coded differential picture using, for example, a variable length coding (VLC) method.

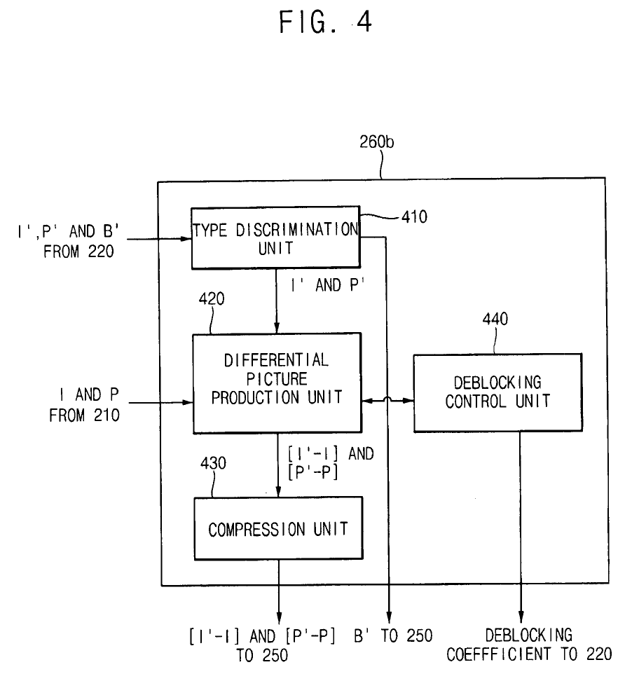

FIG. 4 is a block diagram illustrating another example embodiment of a differential picture encoder in the video image system of FIG. 2.

Referring to FIG. 4, the differential picture encoder 260b may include a type discrimination unit 410, a differential picture production unit 420, and/or a compression unit 430. In addition, the differential picture encoder 260b further may include a deblocking control unit 440 configured to control a deblocking filter strength, as compared to the differential picture encoder 260a in FIG. 3.

The differential picture encoder 260b may receive pictures I and/or P reconstructed using video decoding and/or filtered pictures I′, P′, and/or B′ and may output compressed differential pictures I′-I and/or P′-P and/or filtered non-reference picture B′.

The type discrimination unit 410 may receive the filtered pictures I′, P′, and/or B′ and may discriminate according to the type of received picture. When the type of received picture is an I picture or a P picture, the differential picture production unit 420 may compare the filtered picture with the corresponding reconstructed picture to produce a differential picture. The compression unit 430 may compress the differential picture using, for example, a lossless compression method. In an example embodiment, the compression unit 430 codes the differential picture using, for example, a RLC method and again codes the coded differential picture using, for example, a VLC method.

The deblocking control unit 440 may decide whether the bus 240 is heavily occupied by the differential picture I′-I or P′-P with respect to a reference value, so that the compression unit 430 may compress the differential picture I′-I or P′-P in the case in which the occupancy of the bus 240 is less than the reference value. In the case in which the occupancy of the bus 240 is equal to or more than the reference value, the deblocking control unit 440 may control a deblocking coefficient that determines the deblocking filter strength. Namely, in the case in which the occupancy of the bus 240 by the differential picture increases because of excessive filtering strength, the deblocking control unit 440 may lower the filtering strength, thereby reducing the size of the differential picture.

An encoding operation of the differential picture encoders 260a and 260b shown in FIG. 3 and FIG. 4 may be performed on a block-by-block basis. In this case, the type discrimination units 310 and 410 may discriminate the picture type of the block that is to be encoded among the types of I picture, P picture, and/or B picture.

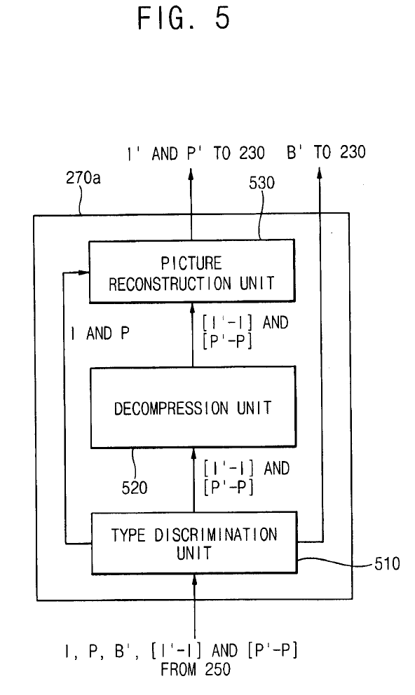

FIG. 5 is a block diagram illustrating an example embodiment of a differential picture decoder in the video image system of FIG. 2.

Referring to FIG. 5, the differential picture decoder 270a may include a type discrimination unit 510, a decompression unit 520, and/or a picture reconstruction unit 530.

The differential picture decoder 270a may receive pictures I and/or P, reconstructed using video decoding, compressed differential pictures I′-I and/or P′-P, and/or filtered non-reference picture B′, and may output filtered pictures I′, P′, and/or B′.

The type discrimination unit 510 may discriminate according to the type of compressed differential picture. When the type of compressed differential picture is an I picture or a P picture, the decompression unit 520 may decompress the compressed differential picture and may produce a differential picture. In an example embodiment, the decompression unit 520 may decode the compressed differential picture using, for example, a variable length decoding (VLD) method and again may decode the VLD-decoded differential picture using, for example, a run length decoding (RLD) method to produce a differential picture. The picture reconstruction unit 530 may mix the picture reconstructed by the video decoding with the differential picture to reconstruct a filtered picture.

A decoding operation of the differential picture decoder 270a shown in FIG. 5 may be performed on a block-by-block basis. In this case, the type discrimination unit 510 may discriminate the picture type of the block that is to be decoded among the types of I picture, P picture, and/or B picture.

According to MPEG-2 standard, the B picture is not used as the reference picture for producing the prediction picture required for the encoding or the decoding. In other words, the B picture is a non-reference picture. The I and P pictures may represent the reference pictures capable of being used to encode or decode the other pictures and the B picture may represent the non-reference picture. In the case in which the video image system 200 in FIG. 2 is embodied on the basis of the H.264 video decoder, the I and P pictures may be replaced with the reference pictures and the B picture may be replaced with the non-reference picture. In the H.264 standard, the B picture may be used as the reference picture for producing the prediction picture required for encoding or decoding other pictures. Accordingly, it may be understood that, in the description of example embodiments, the I and P pictures may designate the reference pictures and the B picture may designate the non-reference picture.

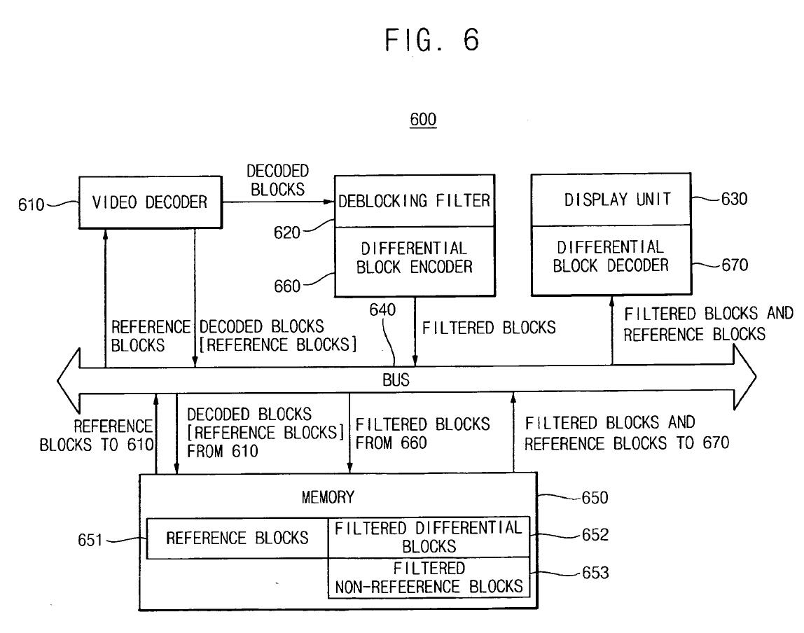

In the case in which a video encoder divides an picture into a reference region or regions and a non-reference region or regions to perform video coding, a picture reconstructed by the video decoder may be divided into the reference region(s) and the non-reference region(s). More specifically, the reference region(s) may be segmented into reference blocks and the non-reference region(s) may be segmented into non-reference blocks. Such a video image system in which video decoding may be performed for the reference blocks and the non-reference blocks will be discussed with reference to FIG. 6.

FIG. 6 is a block diagram illustrating a video image system that includes a video image post-processing apparatus according to another example embodiment.

The video image system 600 may include a video decoder 610, a deblocking filter 620, a display unit 630, a bus 640, a memory 650, a differential block encoder 660, and/or a differential block decoder 670.

The video decoder 610 may decode compressed video data to reconstruct coded video blocks. The reconstructed blocks may be divided into reference blocks that are to be used in a decoding process for other blocks and non-reference blocks that are not to be used in the decoding process for the other blocks.

The video decoder 610 may receive the reference blocks reconstructed in the preceding decoding process from the memory 650. The video decoder 610 may decode the compressed video data using the reference blocks. The video decoder 610 may provide the blocks reconstructed in the decoding process to the deblocking filter 620 and/or may store the reference blocks of the reconstructed blocks in the memory 650 for the next decoding process.

The deblocking filter 620 may filter the reconstructed blocks. The differential block encoder 660 may produce compressed differential blocks for the reference blocks of the filtered blocks. The compressed differential blocks and/or the filtered non-reference blocks may be stored in the memory 650.

The reference blocks 651, the compressed differential blocks (that is, the filtered differential blocks 652), and/or the filtered non-reference blocks 653 stored in the memory 650 may be provided to the differential block decoder 670. The differential block decoder 670 may reconstruct the filtered reference blocks using the reference blocks and/or the compressed differential blocks. The filtered reference blocks, together with the filtered non-reference blocks, may form a filtered picture and the filtered picture may be provided to the display unit 630.

The display unit 630 may display the filtered picture.

As described above, a video image post-processing apparatus according to example embodiments may reduce memory-space requirements and/or amounts of data transferred through the bus. Therefore, a video image system including a video image post-processing apparatus according to example embodiments may be implemented in a small size and with low cost. Also, the video image system may enhance efficiency of bus utilization.

While the example embodiments have been particularly shown and described, it will be understood by those of ordinary skill in the art that various changes in form and details may be made therein without departing from the spirit and scope of the present invention as defined by the following claims.

What is claimed is:

1. An apparatus for post-processing a video image, comprising:
a filter configured to remove artifacts from pictures decoded by a video decoder;
a differential picture encoder configured to produce compressed differential pictures based on the decoded pictures and the pictures filtered by the filter; and
a differential picture decoder configured to reconstruct the filtered pictures based on the decoded pictures and the compressed differential pictures.

2. The apparatus of claim 1, wherein the filter is configured to remove block artifacts from the decoded pictures.

3. The apparatus of claim 1, wherein the differential picture encoder comprises:
a type discrimination unit configured to discriminate types of the filtered pictures;
a differential picture production unit configured to compare the filtered pictures with the decoded pictures to produce differential pictures when the filtered pictures are I pictures, P pictures, or I pictures and P pictures; and
a compression unit configured to compress the differential pictures.

4. The apparatus of claim 3, wherein the compression unit is configured to code the differential pictures using a run length coding (RLC) method.

5. The apparatus of claim 4, wherein the compression unit is further configured to again code the RLC coded differential pictures using a variable length coding (VLC) method.

6. The apparatus of claim 3, wherein the differential picture encoder further comprises:
a filter control unit configured to control a filtering coefficient according to a bandwidth of the differential pictures.

7. The apparatus of claim 1, wherein the differential picture decoder comprises:
a type discrimination unit configured to discriminate types of the compressed differential pictures;
a decompression unit configured to decompress the compressed differential picture in order to produce differential pictures when the compressed differential pictures are I pictures, P pictures, or I pictures and P pictures; and
a picture reconstruction unit configured to mix the decoded pictures with the differential pictures in order to reconstruct the filtered pictures.

8. The apparatus of claim 7, wherein the decompression unit is configured to decode the compressed differential pictures using a variable length decoding (VLD) method.

9. The apparatus of claim 8, wherein the decompression unit is further configured to again decode the VLD decoded differential pictures using a run length decoding (RLD) method.

10. An apparatus for post-processing a video image, comprising:
a filter configured to remove artifacts from pictures decoded by a video decoder;
a differential region encoder configured to produce a compressed differential region or regions based on a filtered reference region or regions and a decoded reference region or regions corresponding to the filtered reference region or regions; and
a differential region decoder configured to reconstruct the filtered reference region or regions based on the corresponding decoded reference region or regions and the compressed differential region or regions;
wherein the filtered reference region or regions are included in the pictures filtered by the filter, and
wherein the decoded reference region or regions are included in the decoded pictures.

11. The apparatus of claim 10, wherein the differential region encoder comprises:
a type discrimination unit configured to discriminate the reference region or regions from non-reference region or regions in the filtered pictures;
a differential region production unit configured to compare the filtered reference region or regions with the corresponding decoded region or regions to produce differential region or regions; and
a compression unit configured to compress the differential region or regions.

12. The apparatus of claim 10, wherein the differential region decoder comprises:
a type discrimination unit configured to discriminate types of the compressed differential region or regions;
a decompression unit configured to decompress the compressed differential region or regions in order to produce differential region or regions; and
a reference region reconstruction unit configured to mix the corresponding decoded reference region or regions with the differential region or regions in order to reconstruct the filtered reference region or regions.

13. A method for post-processing a video image, the method comprising:
filtering pictures decoded by a video decoder to remove artifacts from the decoded pictures;
producing compressed differential pictures based on the decoded pictures and the filtered pictures; and
reconstructing the filtered pictures based on the decoded pictures and the compressed differential pictures.

14. The method of claim 13, wherein filtering the pictures decoded by the video decoder comprises removing block artifacts from the decoded pictures.

15. The method of claim 13, wherein producing the compressed differential picture comprises:
discriminating types of the filtered pictures;
comparing the filtered pictures with the decoded pictures in order to produce differential pictures when the filtered pictures are I pictures, P pictures, or I pictures and P pictures; and
compressing the differential pictures.

16. The method of claim 15, wherein compressing the differential pictures comprises coding the differential pictures using a run length coding (RLC) method.

17. The method of claim 16, wherein compressing the differential pictures further comprises again coding the RLC coded differential pictures using a variable length coding (VLC) method.

18. The method of claim 15, wherein producing the compressed differential picture further comprises:
controlling a filtering coefficient according to a bandwidth of the differential pictures.

19. The method of claim 13, wherein reconstructing the filtered pictures comprises:
discriminating types of the compressed differential pictures;
producing differential pictures by decompressing the compressed differential pictures when the compressed differential pictures are I pictures, P pictures, or I pictures and P pictures; and
reconstructing the filtered pictures by mixing the decoded pictures with the differential pictures.

20. The method of claim 19, wherein producing the differential pictures comprises decoding the compressed differential pictures using a variable length decode (VLD) method.

21. The method of claim 20, wherein producing the differential pictures further comprises again decoding the VLD decoded differential pictures using a run length decoding (RLD) method.

22. A video image system, comprising:
a video decoder configured to decode coded video images in order to reconstruct reference pictures and non-reference pictures;
a filter configured to remove artifacts from the reference pictures and the non-reference pictures;
a differential picture encoder configured to produce compressed differential pictures based on the reference pictures and the filtered reference pictures;
a memory configured to store the reference pictures, the filtered non-reference pictures, and the compressed differential pictures;
a differential picture decoder configured to reconstruct the filtered reference pictures based on the reference pictures and the compressed differential pictures; and
a display unit configured to display the filtered non-reference pictures and the reconstructed filtered reference pictures;
wherein the reference pictures are used in a decoding process, and
wherein the non-reference pictures are not used in the decoding process.
